(19) United States
(12) Patent Application Publication
(10) Pub. No.: US 2009/0016565 A1
(43) Pub. Date: Jan. 15, 2009

(54) Image analysis

(76) Inventor: Sriram Kulumani, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/827,348

(22) Filed: Jul. 11, 2007

(51) Int. Cl. G06K 9/00; G06F 7/00

(52) U.S. Cl. 382/100; 707/104.1

(57) ABSTRACT

Digital image data generated by an image capture device is analyzed in an example to identify the image capture device. A characteristic of the digital image data is identified, and used to provide suggestion information describing how the image capture device can be configured to improve subsequently-generated images.

### BACKGROUND

Digital cameras have become increasingly popular for taking photographs. However, many users of digital cameras take pictures using camera settings and techniques that do not provide optimum results. For example, some users implement the simplest or default settings for their cameras, and may not be aware of special features provided by the camera to improve images in various circumstances. Such users may be able to take better photographs if they adjusted camera parameters and, revised their photographic technique and/or utilized appropriate accessories.

### DESCRIPTION OF THE DRAWINGS

Features of exemplary embodiments will become apparent from the description, the claims, and the accompanying drawings in which:

FIG. 1 is a functional block diagram of one embodiment of a system for processing digital images using a local processing unit.

FIG. 2 is a flow chart illustrating one embodiment of a method for processing digital images.

FIG. 3 is a functional block diagram of an embodiment of a system for processing images using a network-based application service provider.

### DETAILED DESCRIPTION

Referring to the BACKGROUND section above, with the increasingly widespread use of digital cameras and processing of digital images, it may be desirable that users be informed as to ways in which the quality of captured images can be improved. In order to accomplish this task, photos that have been previously taken by a user can be analyzed, towards identifying problems with the photos and ways that those problems could be avoided corrected or mitigated in subsequently-captured images. In an exemplary embodiment, the analysis may include determination of the camera model with which the images were captured, and furnishing of information describing how the specific settings that are available on the identified camera model can be adjusted to improve subsequent photographs. Such analysis can be readily performed in a variety of contexts, particularly in contexts during which a user transfers digital photos that they have taken, such as a software application on a personal computer, a photo processing and printing kiosk, or a web-based photo sharing and printing portal.

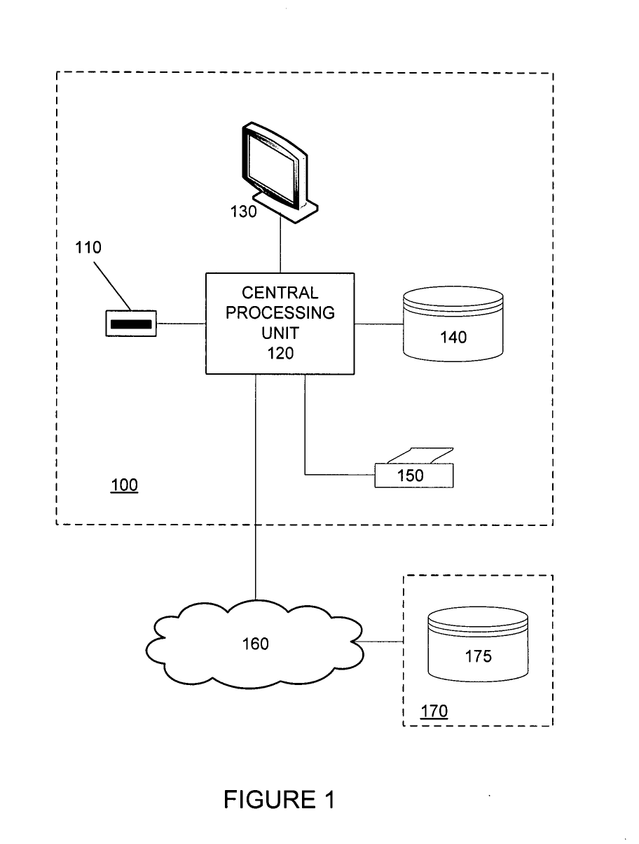

Turning to FIG. 1, an embodiment of an apparatus 100 is shown in an example providing local processing of digital image data, such as a photo kiosk or a personal computing system. Apparatus 100 comprises a digital media reader 110, central processing unit (CPU) 120, display 130, local database 140 and print module 150. A communication link is provided through which apparatus 100 communicates with remote data store 170 via Internet 160. Remote data store 170 includes remote database 175.

As illustrated in FIG. 1, CPU 120 and local database 140 are depicted schematically as separate elements. However, it is understood that local database 140 could readily be implemented as a database software module executed by either CPU 120 or a separate processing unit. Further, the description generally herein of software and functionality being implemented by CPU 120 should be understood to also encompass implementations of software modules and/or functionality by distributed processing systems featuring any number of hardware components.

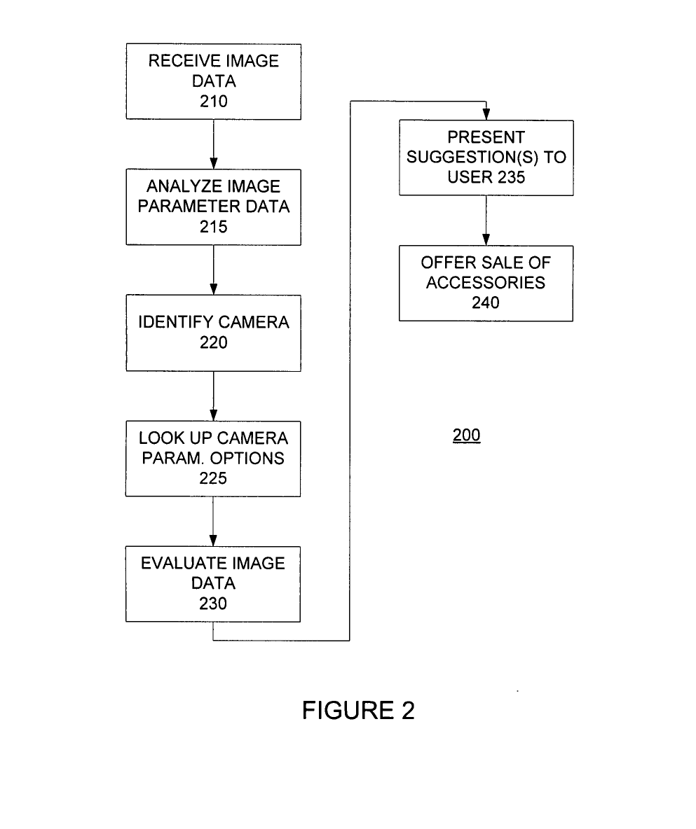

FIG. 2 illustrates a process 200 that can be implemented using the apparatus of FIG. 1. In step 210, digital image data is received. The digital image data is typically generated by a digital image capture device, such as a digital camera, and stored on digital memory media. As implemented by apparatus 100, digital media reader 110 accepts media containing digital images, such as memory cards, CDROMs or DVD media. The digital image data is transferred from digital media reader 110 to CPU 120. The transfer of image data can be effected through operation of an image transfer software module implemented by CPU 120.

Parameters associated with the image data received in step 210 are then analyzed in step 215. In the context of apparatus 100, CPU 120 operates to analyze digital images received from digital media reader 110. For example, in step 215, CPU 120 may identify image parameter header data stored within each image file through operation of a parameter analysis module. The image parameter header data may include information such as the time and date at which the picture was taken, camera make and model, camera orientation, aperture, shutter speed, focal length, metering mode, ISO speed, flash settings, and/or color space. One format which can be used for recording such image parameter header data within digital image data is the Exchangeable image file format, commonly referred to as Exif.

The image parameter data can then be used by CPU 120 to identify the make and model of the camera with which a digital image was taken (step 220). Step 220 can be implemented via a camera identification module, which can be implemented in software using CPU 120. Once the camera has been identified, CPU 120 operates to look up available settings, parameters and options that are provided by the identified camera make and model (step 225). For example, CPU 120 can query local database 140 using camera make and model information recovered in step 220, to receive available parameter data for the corresponding camera.

Local database 140 is populated with available parameter settings for a variety of popular digital cameras. CPU 120 may then periodically operate to update the data available within local database 140, by querying remote database 175, maintained within remote data store 170, for updated parameter data. By maintaining a centralized source for database updates, parameter data for new camera models can be readily deployed to a number of implementations of apparatus 100, which may be located remotely from one another.

In step 230, image data for one or more images received during step 210 is evaluated, towards identifying problems with, and/or non-ideal characteristics of, the images and/or the way in which the images were taken. It is contemplated that a variety of different types of evaluation can be performed by one or more image analysis software modules.

In accordance with one exemplary mode of analysis, CPU 120 evaluates the composition of a photograph, towards evaluating whether the image complies with traditional rules of preferred composition for photographs, such as the “Rule of Thirds.” If the evaluation reveals attributes such as photograph subjects or horizon lines consistently centered in the frame, CPU 120 may determine that the user should be presented with an explanation of the Rule of Thirds for consideration during future picture-taking sessions.

In accordance with another exemplary mode of analysis, CPU 120 may evaluate the brightness level of a photograph towards determining whether the photograph is underexposed or overexposed. If the evaluation of step 230 reveals poor exposure, CPU 120 may determine to present the user with applicable information concerning such topics as the use of the camera's automatic exposure modes, the use of exposure compensation controls, and/or composing scenes with reasonable dynamic range.

In accordance with another exemplary mode of analysis, CPU 120 may analyze Exif header information for a plurality of images, towards determining whether the changes, or lack of changes, in camera parameters suggests a potential problem or lack of understanding on the part of the user. By analyzing a series of multiple images taken by the user (whether the analysis focuses on image header data or the images depicted), it may be possible to identify problems that would otherwise be undetected through review of any single image. Analysis of a set of multiple images can also be used to prioritize the selection of issues and information to be presented to the user, such that the presentation of issues begins with, or is limited to, issues that are most common or recurring.

For example, if the evaluation of step 230 reveals that the camera is set in manual or aperture-priority exposure modes, with identical aperture settings, in a plurality of photos taken at different times, the evaluation may reveal a lack of understanding on the part of the user as to the significance of the aperture setting and/or the proper technique for changing it. It can then be determined that the user should be presented with instruction as to how the aperture setting is changed, and/or how the camera can be set to a program exposure mode such that the camera itself selects an appropriate aperture setting. If the specific camera model with which the pictures were taken is identified in step 220, then information describing use of the aperture controls available on the user's specific camera can be provided.

In accordance with other modes of analysis, characteristics of a single image can be analyzed. For example, CPU 120 may analyze the overall sharpness of an image. If the image is consistently blurry throughout the frame, CPU 120 may determine to present the user with a tutorial on, e.g., controlling the camera's ISO setting to increase shutter speed, controlling the camera's shutter speed through use of shutter priority exposure mode, or improved camera handholding techniques. If blur is detected and image header information indicates use of a long telephoto focal length and slow shutter speed, CPU 120 may determine to present the user with a recommendation to use a tripod to better stabilize the camera. If the combination of shutter speed, aperture and ISO setting indicates that the photograph was taken during low-light conditions without firing of a flash, CPU 120 may determine to present the user with additional suggestions for low-light photography, such as use of a tripod and/or flash unit.

In accordance with another exemplary mode of analysis, CPU 120 may analyze the sharpness of different portions of an image. If facial detection determines that an individual's facial features are blurry, yet other portions of the image are sharp, CPU 120 may determine to present the user with a tutorial on controlling focus zones to ensure the subject of the photograph is in focus, and/or how to control aperture settings to increase depth of field.

In accordance with another exemplary mode of analysis, CPU 120 implements an algorithm for detection of “redeye” that can be caused by the use of an on-camera flash. Specifically, if facial detection analysis determines that an individual's eyes have a red appearance, while Exif header information indicates that an on-camera flash was fired, and the camera identification in step 220 reveals that the image was taken with a camera having a hot-shoe for mounting of a separate flash unit, CPU 120 may determine to present the user with information describing how and why a hot-shoe mounted flash can be used to avoid or reduce redeye problems.

In step 235, the user is presented with suggestions and/or information corresponding to the determination made in step 230. In so doing, the camera model identified in step 220 can be used to present the user with information specific to their particular camera model. The suggestions and/or information can be provided by a suggestion engine software module that may be implemented by CPU 120 to perform determinations, such as those described above, as to the information that should be presented to the user.

For example, if CPU 120 determines in step 230 that the user should adjust the camera's exposure compensation, the user can be presented in step 235 with a visual depiction of the user's specific model of camera, highlighting the location of buttons and/or dials that can be adjusted in order to change the exposure compensation for that particular model of camera, and providing a text description of the process for changing exposure compensation.

In another example, if it is determined in step 230 that the user may have accidentally left their camera in manual mode rather than programmed exposure mode, the user can be presented in step 235 with a depiction of the camera model that was identified in step 220, along with an indication as to how the camera can be adjusted from a manual exposure mode to a programmed exposure mode.

In another example, if it is determined in step 235 that the user experiences motion blur in dim light conditions, the user can be presented in step 235 with a depiction of their specific model of camera, along with an indication as to how the camera's on-board flash can be activated, and/or a description of how an external flash unit can be mounted and used.

In some embodiments, the systems described herein can further be used to facilitate or promote the targeted sale of accessory products, step 240. By considering the evaluation of user images in step 230, along with the identification of the user's camera model in step 220, it is possible to provide a timely offer for sale of accessories which are both relevant to the user's photography experience, as well as compatible with the user's particular camera. Such a targeted and timely offer for sale may act to effectively promote the sale of accessory products.

For example, if it is determined in step 230 that the user is experiencing red-eye problems in portraits due to use of an on-board flash, and the user is presented in step 235 with a suggestion to use a separate, hot-shoe mounted flash unit, in step 240, the user can be presented with an opportunity to purchase a flash unit which would be compatible with the camera model identified in step 220. For example, in some embodiments, CPU 120 could implement an online product ordering interface via display 130. In other embodiments, such as systems implemented at a kiosk in a retail photography store, the user can be provided with a product name and location for facilitating its purchase.

Similarly, if it is determined in step 230 that the user would benefit from use of a tripod, and the user is presented in step 235 with a suggestion to use a tripod, in step 240, the user can be presented with an opportunity to purchase a tripod.

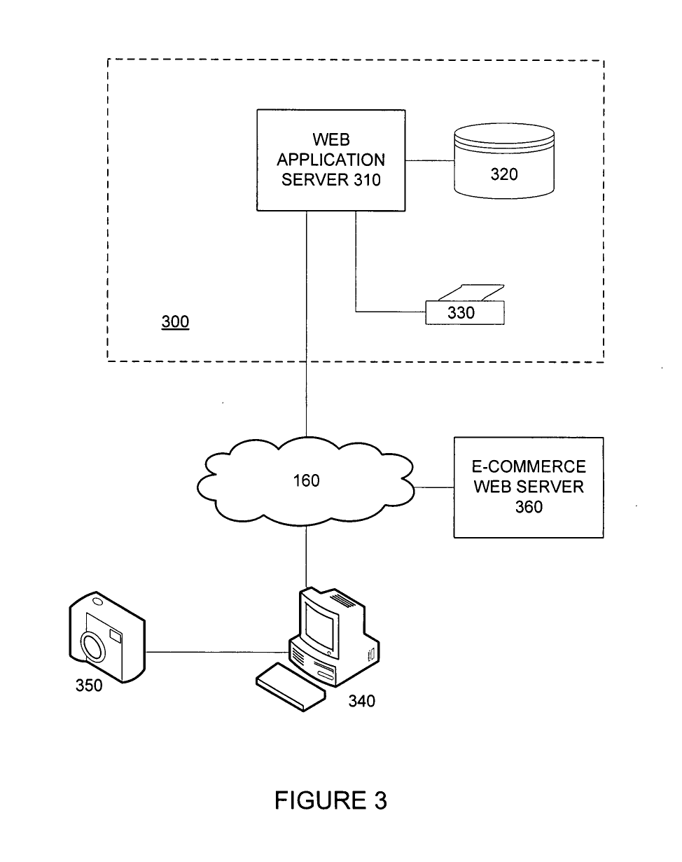

In addition to the type of implementation illustrated in FIG. 1, it is also understood that the present system and method can be implemented in other contexts, including, without limitation, a network-based application service provider, such as an Internet portal for photo printing or photo sharing. One exemplary embodiment of such an implementation is illustrated in FIG. 3. Referring to FIG. 3, system 300 provides a network-based application service provider system adapted for communication with a personal computer 340 via Internet 160. Digital images can be downloaded from digital camera 350 to personal computer 340. The images can then be uploaded via a web site application to system 300 via Internet 160.

Within system 300, web application server 310 provides a web portal for uploading of digital images. Web application server 310 also implements a photo analysis engine which can implement the method of FIG. 2, and the photo analysis features described above in connection with CPU 120. Specifically, web application server 310 can analyze digital image file header information to identify camera information and settings used to take a picture. If the camera model is identified, web application server 310 can query database 320 to identify the parameters and ranges of configuration available for the identified camera model. Suggestions can then be provided to the user of personal computer 340 via a web portal interface to correct potential problems with photos, and/or to facilitate the purchase of accessories. In some embodiments in which the purchase of accessories is suggested, web application server 310 may further implement an e-commerce web portal for the direct sale of camera accessories. In other embodiments, web application server 310 may provide links to a web site implemented on separate e-commerce web server 360, through which accessories can be purchased.

In some embodiments, system 300 may include photo printing engine 330 to provide functionality whereby prints of uploaded images can be ordered, as the photo analysis and recommendation features of system0 may promote increased sales of photo prints. For example, by providing features which lead users to take better photographs, the users are more likely to be satisfied by a greater number of their pictures, and accordingly, they are more likely to order a greater number of prints.

The steps or operations described herein are examples. There may be variations to these steps or operations without departing from the spirit of the invention. For example, the steps may be performed in a differing order, or steps may be added, deleted, or modified.

Although exemplary embodiments of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

What is claimed is:

1. A digital computing system comprising:
a user interface for receiving one or more digital image files;
a database containing equipment information describing available setting and parameter values corresponding to a plurality of digital camera models;
a camera identification module for identifying a user camera model used to create the one or more digital image files using information contained within the one or more digital image files;
an image analysis module for identifying one or more characteristics of the digital image files; and
a suggestion engine which uses the equipment information and the identified characteristics of the digital image files to present the user with suggestion information concerning ways to configure the user camera differently to improve subsequently-generated digital images.

2. The digital computing system of claim 1, in which the digital computing system comprises a photo processing kiosk having one or more digital microprocessors that operate to implement the database, camera identification module, image analysis module and suggestion engine.

3. The digital comprising system of claim 2, further comprising a remote database which provides data used to update information stored within the database.

4. The digital comprising system of claim 1, in which the user interface comprises a web portal operable to receive the one or more digital image files via the Internet.

5. The digital comprising system of claim 4, in which the suggestion engine is further operable to display accessory purchase information for facilitating the purchase of one or more accessories that are compatible with the user camera model.

6. The digital comprising system of claim 5, in which the accessory purchase information comprises a URL address.

7. The digital comprising system of claim 1, in which the suggestion information comprises an image depicting part or all of a camera corresponding to the user camera model.

8. The digital comprising system of claim 1, in which the suggestion information comprises parameters which are available for implementation by the user camera model.

9. The digital comprising system of claim 1, in which the camera identification module uses Exif header information stored within the one or more digital image files.

10. A method, comprising the steps of:
analyzing digital image data generated by an image capture device;
identifying the image capture device using information contained within the digital image data;
identifying a characteristic of the digital image data; and
using the identified characteristic to provide suggestion information describing how the image capture device can be configured to improve subsequently-generated digital images.

11. The method of claim 10, wherein the step of identifying the image capture device using information contained within the digital image data comprises the step of extracting camera model information from Exif headers.

12. The method of claim 10, wherein the step of identifying the image capture device using information contained within the digital image data comprises the step of querying a database using information extracted from the digital image data.

13. The method of claim 10, wherein the step of identifying a characteristic of the digital image data comprises the step of identifying a characteristic of an image that is represented by the digital image data.

14. The method of claim 10, wherein the step of identifying a characteristic of the digital image data comprises the step of identifying one or more camera settings reflected by header information within the digital image data.

15. The method of claim 10, wherein the step of using the identified characteristic to provide suggestion information comprises the step of displaying a graphic depiction of the image capture device.

16. The method of claim 10, further comprising the step of providing an Internet web site through which the digital image data can be uploaded, and through which the suggestion information can be provided.

17. A method, comprising the steps of:
analyzing digital image data generated by an image capture device;
identifying the image capture device using information contained within the digital image data;
identifying a characteristic of the digital image data;
using the identified characteristic to provide accessory information describing an accessory that can be used in conjunction with the image capture device to improve subsequently-generated digital images; and
facilitating a transaction through which the accessory can be purchased.

18. The method of claim 17, further comprising the step of providing an Internet web site through which the digital image data can be uploaded, and through which the accessory information can be provided.

19. The method of claim 17, wherein the step of facilitating a transaction through which the accessory can be purchased comprises the step of providing a link to an Internet URL, through which the accessory can be purchased.

20. The method of claim 17, further comprising the step of providing a photo processing kiosk located proximate to a retail establishment; and wherein the step of facilitating a transaction through which the accessory can be purchased comprises the step of providing information facilitating the purchase of the accessory from the retail establishment.
